(19) United States
(12) Patent Application Publication
(10) Pub. No.: US 2026/0096509 A1
(43) Pub. Date: Apr. 9, 2026

(54) AGRICULTURAL WORK MACHINE AND METHOD FOR CONTROLLING OPERATION THEREOF TO AVOID CROP MATERIAL PLUGGING AND/OR REMOVE PLUGGED CROP MATERIAL

(71) Applicant: Deere & Company, Moline, IL (US)

(72) Inventors: MAHESH SOMAROWTHU, Pune (IN); DARIN L. ROTH, Mount Pleasant, IA (US); Pankaj R. Kadam, Pune (IN); Jayadhar Alla, Pune (IN); Taranpreet Kalra, Pune (IN)

(21) Appl. No.: 18/905,214

(22) Filed: Oct. 3, 2024

(51) Int. Cl. A01D 41/127; A01D 41/14; A01D 75/18

(52) U.S. Cl. CPC A01D 41/1277; A01D 41/141; A01D 75/18

(57) ABSTRACT

A computer-implemented method is provided for operating a self-propelled agricultural work machine comprising a first crop material processing element (e.g. header), a second crop material processing element (e.g. transverse auger), an engine, and respective drive units. The method comprises sensing unprocessed crop characteristics (e.g., density, moisture) and/or operating characteristics for the drive units in real-time during machine operation, and based on at least one of the sensed crop characteristics and/or operating characteristics, automatically predicting and/or determining an error condition corresponding to crop material blockage. Responsive to the error condition, the machine enters a second operating mode, wherein one or more drive units are controlled according to an intervention plan associated with the predicted and/or determined error condition, e.g., adjusted power distribution, reversal of rotational motion for processing elements, adjustment of gaps between elements, etc. The first operating mode is resumed upon completion of the correction plan.

### FIELD OF THE DISCLOSURE

The present disclosure relates generally to self-propelled agricultural work machines for traversing a work area and processing crop material, more particularly to methods and systems for controlling one or more operations of such a work machine to automatically predict and avoid conditions in which crop material processing elements may become plugged with crop material, and/or to identify conditions in which crop material is plugging one or more crop material processing elements, and wherein the plugged crop material may be automatically removed.

### BACKGROUND

A work area may for example represent a field for growing a crop or other vegetation, or another type of area including terrain to be worked by crop material processing elements associated with an agricultural work machine designed to harvest such crops. Such work machines typically have work tools, or implements, designed to cut or collect crops from the ground, which are subsequently processed in the body of the harvesting machine, or directly deposited on the ground. Exemplary agricultural implements may be forward-mounted, such as for example a header, or may in other examples be mid-mounted or trailed units. In the case of a combine harvester, for example, the work machine threshes the crops, separates the grain from material other than grain (MOG), cleans the grain, and stores the grain in a grain tank. In the case of a forage harvester, the crop is cut, accelerated and blown into a container of a transport vehicle, and in the case of a windrowing system, the crop is cut, may be further processed, and deposited on a field in a swath to create windrows.

Conventional systems and methods are available to unplug such machines after one or more crop handling elements thereof become plugged by crop material, but users have traditionally been required to pull the crop manually to continue with harvesting operations. Apart from the efforts and time required of operators, such a manual process also contributes to crop loss and safety concerns while unplugging the plugged crop.

During a plugged state, reduction of the ground speed of the work machine is also desired to avoid harmful impacts on the work area, such as for example bulldozing of the crop or of the windrow over time. Conventional systems and methods, however, rely on the operator for manual control of the ground speed.

### BRIEF SUMMARY

Various embodiments of a system and/or method are disclosed herein for addressing problems as described above with respect to proactive avoidance and/or reactive assistance in the unplugging of work machines, for example by automatically reversing rotational movement of elements such as the header and converging auger of a rotary platform, which may assist removal of the crop, and then continuing with harvesting. This may promote the efficiencies of users with respect to at least increased performance, increased uptime, reduced cost, and the like.

In addition, various embodiments of a system and/or method as disclosed herein may be configured to automatically control the ground speed during a plugged state, and in some cases based at least in part on characteristics thereof, to more effectively perform an unplugging operation and/or mitigate impacts on the work area during such an operation/state.

Embodiments of a system and/or method as disclosed herein may further or alternatively be configured to automatically predict a likely error condition based for example of sensed crop characteristics such as the density and/or moisture of standing crop material in a field being traversed by the work machine, and to control one or more elements of the work machine to mitigate the effects of the sensed crop characteristics and preferably avoid the error condition. For example, power distribution to the converging auger and/or the header may be increased corresponding to sensed density and/or moisture in the standing crop material being above a specified tolerance.

In one particular and exemplary embodiment, a method is provided for operating a self-propelled agricultural work machine, the work machine comprising a first crop material processing element linked to a first drive unit, and a second crop material processing element linked to a second drive unit, and an engine linked to a propulsion drive unit. The method comprises: in real-time with respect to a first operating mode of the work machine in a work area comprising crop material, sensing one or more crop characteristics for the crop material in the work area, and/or one or more operating characteristics for each of the propulsion drive unit, the first drive unit, and the second drive unit; based on at least one of the one or more monitored operating characteristics, automatically predicting and/or determining an error condition corresponding to crop material blockage; transitioning to a second operating mode, wherein one or more of the propulsion drive unit, the first drive unit, and the second drive unit are controlled according to an intervention plan associated with the predicted and/or determined error condition; and resuming the first operating mode upon completion of the intervention plan associated with the predicted and/or determined error condition.

In one exemplary aspect according to the above-referenced method embodiment, the sensed one or more crop characteristics may comprise density and/or moisture of the crop material in the work area, wherein a first error condition may be predicted based on the sensed density and/or moisture of the crop material in the work area relative to respective tolerances, and the second operating mode responsive to the first error condition may comprise controlling power distribution with respect to at least the first drive unit.

Further according to such an aspect, the first crop material processing element may for example comprise at least one component for transverse crop movement and the second crop material processing element may comprise a cutting mechanism forward of the first crop material processing element, wherein a second error condition is determined based at least in part on a slip ratio corresponding to the first crop material processing element, and the second operating mode responsive to the second error condition comprises controlling a gap between the first crop material processing element and the second crop material processing element.

In another exemplary aspect according to the above-referenced method embodiment, the error condition may be automatically determined at least with respect to a difference between a sensed actual value for at least one of the monitored operating characteristics and a corresponding expected value.

In another exemplary aspect according to the above-referenced method embodiment, the error condition may be automatically determined at least with respect to a difference between a sensed crop input throughput value and a sensed crop output throughput value. For example, the sensed crop input throughput value may correspond to a measured header load and the sensed crop output throughput value may correspond to a measured cross belt motor pressure.

In another exemplary aspect according to the above-referenced method embodiment, the first crop material processing element may comprise at least one component for transverse crop movement and the second crop material processing element comprises a cutting mechanism (e.g., a header), wherein the second operating mode may comprise generating control signals for reversing rotational motion provided by at least one of the first drive unit and the second drive unit, independent of rotational motion provided by the other of the first drive unit and the second drive unit.

In another exemplary aspect according to the above-referenced embodiment, the method may comprise, upon determining the error condition, suspending the first operating mode and generating an alert to a user interface associated with the work machine, wherein the second operating mode may be initiated based on user input from the user interface.

In another exemplary aspect according to the above-referenced method embodiment, the method may comprise monitoring rotational motion provided by at least one of the first drive unit and the second drive unit, and upon detecting the automatic reversal of rotational motion provided by one of the first drive unit and the second drive unit, further automatically reversing rotational motion provided by the other of the first drive unit and the second drive unit.

In another exemplary aspect according to the above-referenced method embodiment, a speed of rotational motion provided by the first drive unit may be controlled based at least in part on a monitored speed of rotational motion provided by the second drive unit.

In another exemplary aspect according to the above-referenced method embodiment, the first crop material processing element may comprise a conditioning roller and the second crop material processing element may comprise a cutting mechanism, wherein the second operating mode may comprise generating control signals for automatically reversing rotational motion provided by the second drive unit and generating control signals to the first drive unit for automatically adjusting a roll gap associated with the conditioning roller.

In another exemplary aspect according to the above-referenced method embodiment, the first crop material processing element may comprise at least one component for transverse crop movement and the second crop material processing element may comprise a conditioning roller, wherein the second operating mode may comprise generating control signals for automatically reversing rotational motion provided by the first drive unit and generating control signals to the second drive unit for automatically adjusting a roll gap associated with the conditioning roller.

In another exemplary aspect according to the above-referenced method embodiment, the correction plan may comprise generating a deceleration profile based on at least a detected ground speed and the at least one of the one or more monitored operating conditions associated with the determining of the error condition, wherein the second operating mode may comprise generating control signals for automatically controlling the propulsion drive unit to a speed of zero according to the deceleration profile.

In another embodiment as disclosed herein, a self-propelled agricultural work machine comprises a first crop material processing element linked to a first drive unit, a second crop material processing element linked to a second drive unit, and an engine linked to a propulsion drive unit. One or more sensors are configured to generate signals representing crop characteristics for unprocessed (i.e., standing) crop material in a work area, and/or operating characteristics for each of the propulsion drive unit, the first drive unit, and the second drive unit, in real-time with respect to a first operating mode of the work machine in the work area. A controller is functionally linked to the one or more sensors, the propulsion drive unit, the first drive unit, and the second drive unit, and configured to direct the performance of steps in a method according to the above-referenced embodiment and optionally one or more of the exemplary aspects thereof.

Numerous objects, features, and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a side perspective view representing a combine harvester as an exemplary work machine according to an embodiment of the present disclosure.

FIG. 2 is an overhead perspective view of the work machine of FIG. 1.

FIG. 3 is a perspective view representing a windrower as an exemplary work machine according to an embodiment of the present disclosure.

FIG. 4 is an overhead perspective view of the work machine of FIG. 3.

FIG. 5 is a block diagram representing an embodiment of a control system according to an embodiment of the present disclosure.

FIG. 6 is a flowchart representing an exemplary method for automatically responding to a crop material plugging condition according to an embodiment of the present disclosure.

FIG. 7 is a flowchart representing an exemplary sub-method with respect to the method of FIG. 6 and according to an embodiment of the present disclosure.

FIG. 8 is a flowchart representing an exemplary sub-method with respect to the method of FIG. 6 and according to an embodiment of the present disclosure.

FIG. 9 is a flowchart representing an exemplary method for predicting and proactively mitigating or avoiding a crop material plugging condition according to an embodiment of the present disclosure.

### DETAILED DESCRIPTION

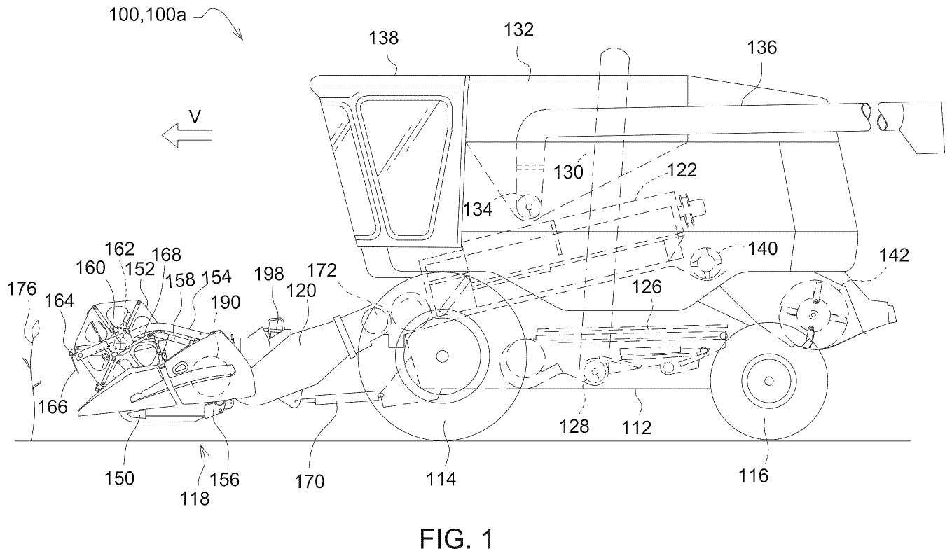

With reference to FIGS. 1-9, exemplary embodiments of systems 200 and methods 300, 400 may further be described herein for controlling configurable (e.g., moveable) crop material processing elements of an agricultural work machine 100 (e.g., a windrower, a swather, a forage harvester, a combine, or the like). In some embodiments, a system and method of the present disclosure may be used to predict an error condition wherein crop material may form a blockage within the work machine, and control settings and/or movements of elements associated with the work machine to avoid or at least mitigate the error condition. In some embodiments, a system and method of the present disclosure may be used to control settings and/or movements of a conditioning arrangement that conditions crop material, in accordance with a determined error condition wherein crop material has formed a blockage within the work machine. In some embodiments, a system and method of the present disclosure may be used to control settings and/or movements of a windrowing arrangement that shapes, positions, arranges, or otherwise controls production of a windrow of crop material, in accordance with a determined error condition wherein crop material has formed a blockage within the work machine.

As used herein, unless otherwise limited or modified, terms of direction such as “forward,” “aft,” “lateral,” “horizontal,” and “vertical” may be defined, at least in part, with respect to the direction in which the work machine or associated implement travels during use. The term “forward” and the abbreviated term “fore” (and any derivatives and variations) refer to a direction corresponding to the direction of travel of the work machine, while the term “aft” (and derivatives and variations) refer to an opposing direction. The term “fore-aft axis” may also reference an axis extending in fore and aft directions. By comparison, the term “lateral axis” may refer to an axis that is perpendicular to the fore-aft axis and extends in a horizontal plane; that is, a plane containing both the fore-aft and lateral axes. The term “vertical,” as appearing herein, refers to an axis or a direction orthogonal to the horizontal plane containing the fore-aft and lateral axes.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature or step in a particular figure is not meant to imply that such feature or step is required in all embodiments and, in some embodiments, may not be included or may be combined with other features or steps.

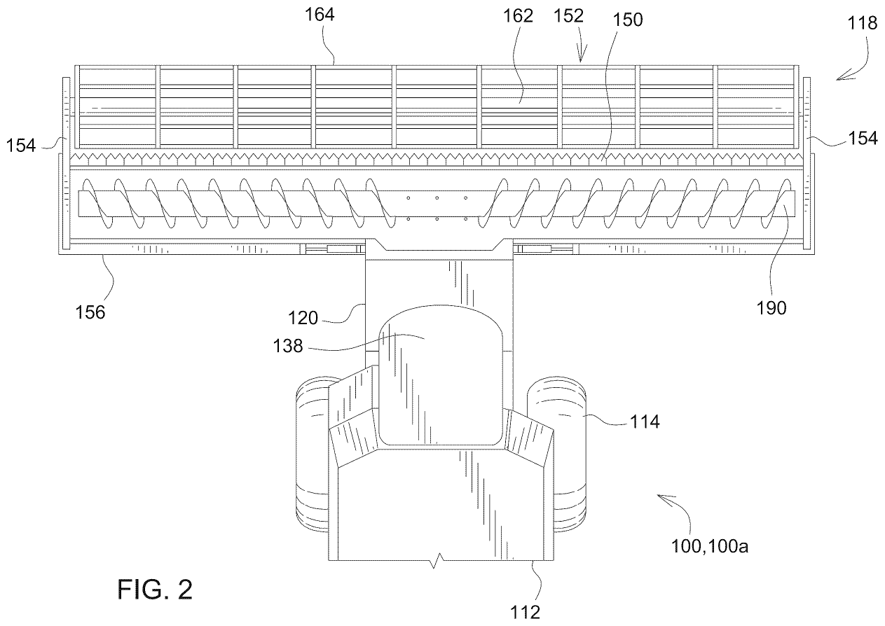

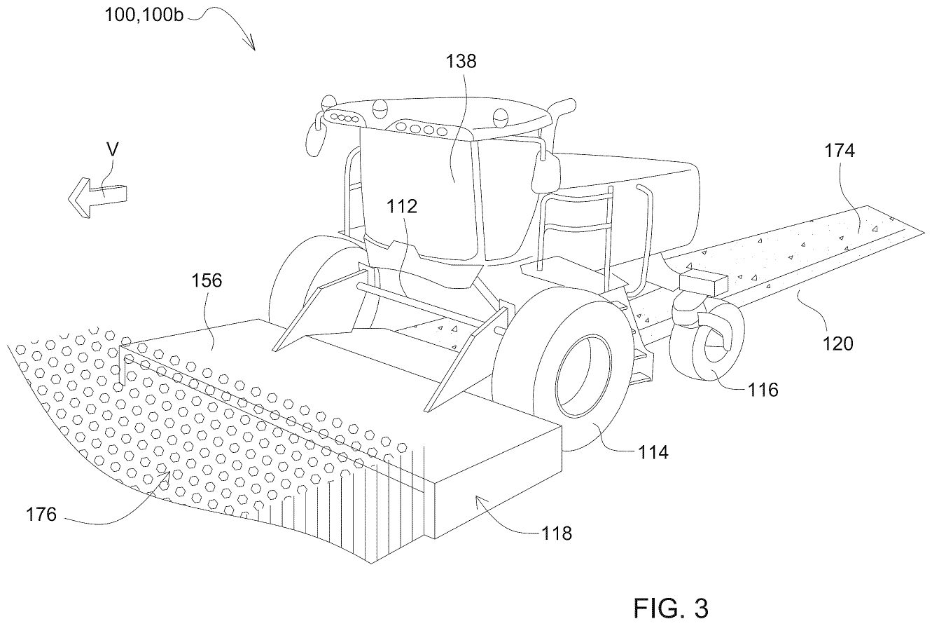

FIGS. 1 and 2 illustrate one example of an agricultural work machine 100 comprising a harvesting combine, which is in no way limiting on the scope of the present disclosure, as specifically contemplating other types of such work machines. In addition, whereas the illustrated work machine is self-propelled, some embodiments of a work machine as disclosed herein may be towed machines. The illustrated work machine 100 has a supporting chassis 112 that is supported from the ground on driven front wheels 114 and steerable rear wheels 116. The wheels 114, 116 are set into a rotating motion by a propulsion drive unit 228 (referenced in FIG. 3) in order to move the work machine 100 over a field to be harvested. In the following, direction references, like forward or rear, refer to the forward direction V of the work machine, which is directed towards the left in FIG. 1.

On the forward end area of the work machine, a harvesting header 118 is releasably mounted, in order to harvest crop 176 in the form of grain or other threshable stalk fruit from the field and to convey it upwardly and rearwardly through a feederhouse assembly 120 to an axial threshing assembly 122 during the harvest operation. The mixture of grain and other material, which penetrates through threshing concaves and separation grates of the axial threshing assembly 122 reaches a cleaning rack 126. Grain cleaned by the cleaning rack 126 is conveyed by a clean grain auger 128 to a grain elevator 130 feeding it into a grain tank 132. The clean grain in the grain tank 132 can be unloaded by an unloading system comprising a transverse auger 134 and an unloading auger 136 or conveyor. The crop residues expelled by the axial threshing assembly 122 may be fed via a beater 140 to a straw chopper 142 which chops and distributes them over the platform width over the field. The mentioned systems are driven by an internal combustion engine and are controlled by an operator from an operator's cab 138. The shown axial threshing assembly 122 with one or more axial threshing and separating rotors is merely an exemplary embodiment and could be replaced by a tangential threshing arrangement with one or more threshing drums and subsequent straw walkers or separation rotors.

The illustrated header 118 comprises a cutting mechanism 150 such as for example a bar of reciprocating knives extending generally over the entire width thereof. A reel 152 also extends generally over the entire width of the header 118, or a part thereof. The outer ends of the reel 152 are supported on arms 154 having rear ends which are supported around axes extending transversely to the forward direction “V” on the frame 156 of the header 118, which frame 156 also extends over the width of the header 118, and extend from there towards the front. Each arm 154 is coupled to a reel position actuator 158 in the form of a hydraulic cylinder, which is pivotally supported on the frame 156 and on the arm 154. The arms 154 and thus the reel 152 are lifted and lowered by adjusting (retracting and expanding) the reel position actuator 158.

On a reel motor 162 that can be set into a rotation motion (during harvest operation, in the counter-clock sense in FIG. 1) by a controllable header drive unit 224 about a header rotation axis 160, tine carriers 164 are supported, extending also over the width of the header 118, or a part thereof, on which tine carriers 164 fingers 166 are mounted. An actuator 168 in the form of a hydraulic cylinder is adapted for a horizontal adjustment of the reel 152 by moving a support bearing of the tube 162 along the arm 154.

A converging auger 190 or equivalent transverse conveyor device (such as for example an auger-like roller or a conveyor belt in some embodiments) is provided to feed the crop cut by the cutting mechanism 150 to the center of the header 118 platform and to feed it into the feederhouse 120 through a rear opening in the frame 156. The converging auger 190 is mounted for rotation about an axis which may be substantially parallel with respect to the header rotation axis 160.

The height of the header 118 over ground may be defined by a header lift actuator 170, controlled for example via a controller 210, the controller 210 adapting the platform height to the ground contour, keeping the header 118 at the desired height over ground or guiding it with a desired pressure on the ground, which pivots the feederhouse 120 and thus the header 118 platform, which is removably mounted thereon, around a horizontal axis 172 extending transversely to the forward direction with respect to the chassis 112 of the work machine 100. As known in the art, the header 118 can pivot around a horizontal, forwardly extending axis (lateral tilt) to follow the ground contour, normally moved by another actuator (not shown) controlled by the controller 210.

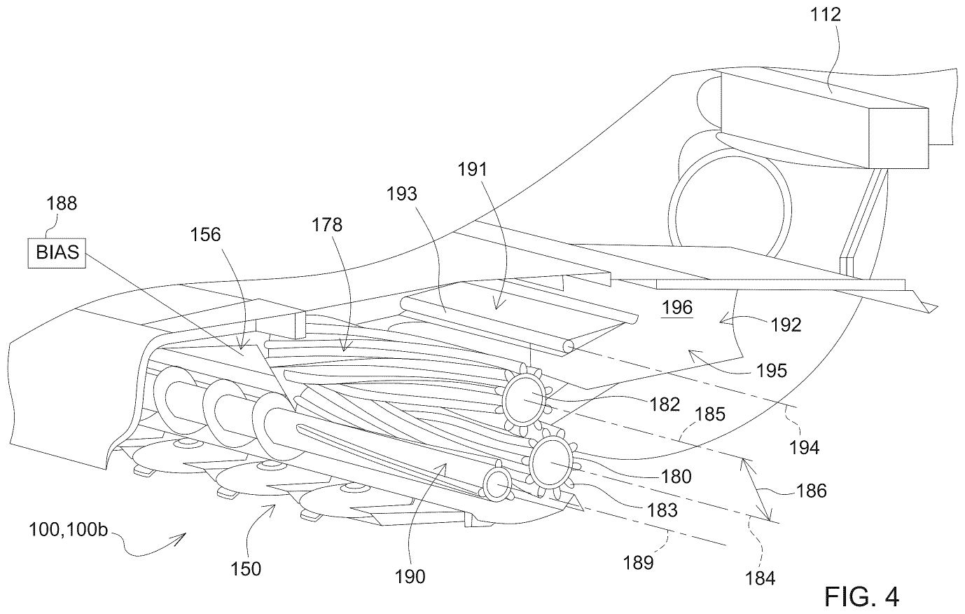

FIGS. 3 and 4 illustrate another example of an agricultural work machine 100b comprising a windrower, again which is in no way limiting on the scope of the present disclosure, as specifically contemplating other types of such work machines 100. Work machines that both condition crop material and form a windrow from the same material will be discussed in this section; however, it will be appreciated that the present teachings may apply to work machines that form windrows without necessarily conditioning the crop material. The present teachings may also apply to work machines that condition (crimp, crush, etc.) crop material without necessarily forming a windrow. Furthermore, the systems and methods of the present disclosure may apply to harvesting of various types of crop materials, such as grasses, alfalfa, or otherwise.

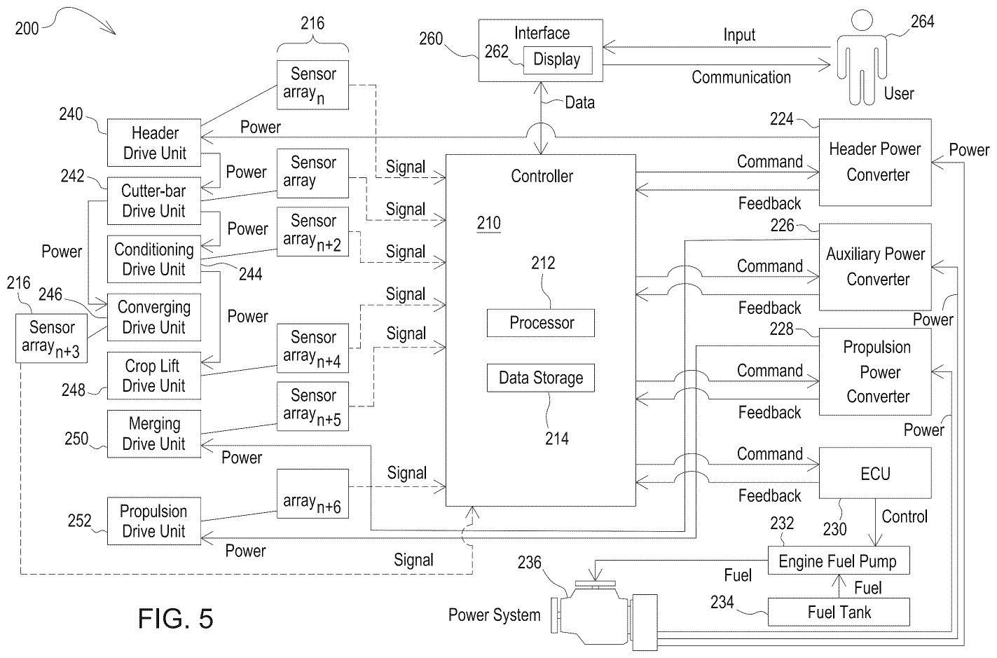

In some embodiments, the work machine 100b broadly comprises a self-propelled work vehicle such as a tractor, and a header 118 (i.e., header attachment). The header 118 may be attached to the front of the tractor. The tractor may include a chassis 112 and an operator cab 138 supported atop the chassis 112. The operator cab 138 may provide an enclosure for an operator and for mounting various user control devices (e.g., a steering wheel, accelerator and brake pedals, etc.), communication equipment and other instruments used in the operation of the work machine 100b, including a user interface 260 (shown in FIG. 5) providing visual (or other) user control devices and feedback. The tractor may also include one or more wheels 114, 116 or other traction elements for propelling the tractor and the header 118 across a field or other terrain. The work machine 100b so configured may form a windrow 174 as it moves along a travel direction indicated by the arrow V.

The header 118 may generally include a frame 156 which is mounted to the chassis 112. The frame 156 may be mounted for movement relative to the chassis 112. For example, the frame 156 may move up and down, at least partly, along a vertical axis relative to the chassis 112 and relative to crop material 176. In some embodiments, the frame 156 may tilt and rotate about an axis that is parallel to the lateral axis. Also, the frame 156 may comprise one or more support elements for supporting the implements (i.e., arrangement of implements, etc.) described below.

The frame 156 may generally include a front end which is open to receive crop material 176 as the work machine 100b moves across the field. In some embodiments, the work machine 100b cuts the crop material 176, then conditions the crop material, and then shapes, places and/or arranges the crop material 176 into the windrow 174 as the work machine 100b moves.

The work machine 100b as illustrated includes a cutting mechanism 150 for severing standing crop material 176 as the work machine 100b moves through the field. In some embodiments, the cutting mechanism 150 may include one or more rotating or reciprocating knives that are proximate the front end of the frame 156.

The work machine 100b may further include a converging auger 190 that is mounted for rotation about an axis 189 substantially parallel to a lateral axis of the work machine 100b. Once the crop material 176 has been cut by the cutting mechanism 150, the converging auger 190 may convey the crop material 176 rearward (generally along a longitudinal axis of the work machine 100b), and away from the cutting mechanism 150 for further processing.

The work machine 100b may include at least one conditioning arrangement 178 (i.e., crop-conditioning implement, tool, etc.). In some embodiments, the conditioning arrangement 178 may comprise a conditioner roller and a member that opposes the conditioner roller, and crop material that passes between the roller and the opposing member are crimped, crushed, or otherwise conditioned by the pressure of the roller on the opposing member. In some embodiments as represented in the Figures, the conditioning arrangement 178 includes a first conditioner roller 180 and a second conditioner roller 182. The first and second conditioner rollers 180, 182 may include projections 183 that project radially and that extend helically about the respective roller. Crop material 176 may pass between the first and second conditioner rollers 180, 182 and the projections 183 may crimp, crush, or otherwise condition the crop material 176 (e.g., the stems of the crop material 176) as it passes between the rollers 180, 182. This conditioning may promote even drying of the crop material 176 as will be appreciated by those having ordinary skill in the art.

The first conditioner roller 180 may be elongate and extend laterally between opposing first and second sides of the frame 156. The first conditioner roller 180 may be mounted for rotation relative to the frame 156 about a rotation axis 184 that is substantially parallel to the lateral axis of the frame 156 and in a substantially fixed position relative to the frame 156. Thus, the first conditioner roller 180 may be referred to as a “fixed” roller.

The second conditioner roller 182 may be substantially similar to the first conditioner roller 180, and mounted to the frame 156 to rotate about an axis 185 which extends substantially along the lateral axis of the frame 156. The second conditioner roller 182 may be spaced apart at a distance from the first conditioner roller 180. In other words, a gap 186 may be defined between the first and second conditioner rollers 180, 182. In the illustrated embodiment, the gap 186 is indicated between the axis 184 of the first conditioner roller 180 and the axis 185 of the second conditioner roller 182. However, the gap 186 may be measured from an outer radial boundary of the first conditioner roller 180 and an opposing outer radial boundary of the second conditioner roller 182. It will be appreciated that the dimension of the gap 186 may affect conditioning of the crop material 176 that passes between the first and second conditioner rollers 180, 182.

Accordingly, in addition to rotation about the axis 185, the second conditioner roller 182 may be supported for movement (linear or angular) relative to the first conditioner roller 180 to vary the dimension of the gap 186. In some embodiments, the second conditioner roller 182 may move at least partially along the vertical axis relative to the first conditioner roller 180.

In the illustrated embodiment of FIGS. 3 and 4, the first and second conditioner rollers 180, 182 are shown at a neutral position relative to each other. The second conditioner roller 182 may be supported to move away from this neutral position (to a displaced position) to thereby increase the gap 186. In some embodiments, the conditioning arrangement 178 may further include at least one biasing member 188. The biasing member 188 may be of any suitable type, such as a mechanical spring, a hydraulic biasing member, etc. The biasing member 188 may be mounted to the frame 156 and to the first and/or second conditioner roller 180, 182. More specifically, in some embodiments, the biasing member 188 may be mounted to the frame 156 and the second conditioner roller 182 such that the biasing member 188 biases the second conditioner roller 182 relative to the frame 156. The biasing member 188 may bias the second conditioner roller 182 toward the neutral position. Biasing force provided by the biasing member 188 may be relatively high so as to maintain the gap 186 (i.e., maintain the first and second conditioner rollers 180, 182 at the neutral position) as the crop material 176 moves through the conditioning arrangement 178. However, a large slug of crop material 176, rocks, or other objects may force the second conditioner roller 182 away from the first conditioner roller 180 against the biasing force of the biasing member 188, thereby increasing the gap 186. Once the material has cleared from between the first and second conditioner rollers 180, 182, the biasing member 188 may bias the second conditioner roller 182 back toward the neutral position.

The windrower 100b as the illustrated and exemplary embodiment of work machine 100 may further include at least one windrowing arrangement (i.e., windrow-shaping implement, tool, etc.) that is configured to shape, arrange, or otherwise form a windrow of the crop material 176. For example, the work machine 100b may include a first windrowing arrangement 191 (e.g., a swath flap arrangement) and a second windrowing arrangement 192 (e.g., a forming shield arrangement). In some embodiments, the first windrowing arrangement 191 may comprise a so-called swath flap (i.e., swath board).

As illustrated, the first windrowing arrangement 191 may include a support structure 193, such as a transversely extending tube, that is attached to the frame 156 at both ends. The first windrowing arrangement 191 may also include a swath flap which may be an elongate member that extends substantially along the lateral axis of the work machine 100b. The first windrowing arrangement 191 may be mounted to the support structure 193 and may extend rearward therefrom. The swath flap may be supported for rotation about a transverse axis 194 of the support structure 193 to change an angle thereof with respect to the ground, for example to rotate between a raised position and a lowered position to change the position of a deflecting surface thereof relative to the crop material 176 received from the conditioning arrangement 178. The second windrowing arrangement 192, or shaping implement, may include at least one forming shield 195. The forming shield 195 may be substantially wide, flat, and smooth and may include at least one deflecting surface 196 having a leading end and a trailing end.

Referring next to FIG. 5, a control system 200 associated with the work machine 100 may include a controller 210 coupled or otherwise in functional communication with various sensors, drive units, actuators, and the like as further described below. The controller 210 may further be functionally linked to an electronic control unit of the work machine 100, or in some embodiments the functions described herein with respect to either or both of these components may be further distributed, integrated into a single control unit, or the like.

An engine control unit 230 in an embodiment as shown receives commands from, and provides feedback to, the controller 210, and further provides control signals to a fuel pump 232 to deliver fuel from a fuel tank 234 to a power system 236, for example including an engine. The power system 236 further generates output power to various power converters, which as illustrated for example may include a header power converter 224, an auxiliary power converter 226, a propulsion power converter 228, and the like. A power converter may comprise a piloted hydraulic circuit, an electrical relay, a torque converter, or the like. The power converters, in turn, may provide output power to respective crop interfacing devices for carrying out functions in a method according to the present disclosure, such as exemplary drive units described below.

The work machine 200 may include a display unit 262, for example associated with a local user interface 260 for input/output with respect to the controller 210. In various embodiments, the display unit 262 may include an LCD display, an LED display, an OLED display, touch display, or other suitable user interface to display information to a user 264 and in various embodiments to further receive input from the user 264.

An array of exemplary sensors 216 or other data sources may provide signals to the controller 210 representative of inputs relevant to machine operation functions as further described herein, including for example inputs from a header drive unit 240, a cutting mechanism drive unit 242, a conditioning drive unit 244, a converging auger drive unit 246, a crop lift drive unit 248, a merging (e.g., cross belt) drive unit 250, a propulsion drive unit 252, and the like. Additional or alternative exemplary sensors 216, dependent for example on the type of work machine application, may provide signals to the controller 210 representative of crop material characteristics for standing (i.e., unprocessed) crop in a work area (i.e., field) being traversed by the work machine. Sensors 216 configured to sense, for example, density and moisture of crop materials in an area forward of the work machine are known in the art and any of which are contemplated as being within the scope of the present disclosure, but may in certain embodiments comprise Impulse-Radio Ultra-Wideband (IR-UWB) radar sensors, lidar sensors, and the like, mounted in a forward-looking arrangement with respect for example to at least the width of a cutting mechanism such as a header of the work machine. Sensors may be integrated sensors, which are combined or “integrated” with signal processing hardware in a compact device. Sensors may be operably connected to, or incorporated within, corresponding actuators of the control system 200 for gathering data therefrom.

Various of the sensors may typically be discrete in nature, but signals representative of more than one input parameter may be provided from the same sensor, and one or more sensors as disclosed herein may further include or otherwise refer to signals provided from other components of the machine control system 200, such as for example the engine control unit 230.

It may further be understood by one of skill in the art that more or less sensors 216 than those illustrated in FIG. 5 may be present and utilized in various embodiments, dependent in part for example on the type of work machine, the type of operation being performed, etc., and that the number and order of the sensors shown is merely exemplary.

Monitored actual values for certain operating characteristics may in some embodiments be compared against commanded values for those operating characteristics to identify and record differences, which may for example correspond to slippage or blockage of one or more crop material processing components.

Measured changes in values for the pressure or load corresponding to the hydraulic or electric motor of a crop material processing element (e.g., header) may inversely correspond to changes in speed of the drive unit for the same crop material processing element (higher pressure/load corresponds to slower speed of the header drive, lower pressure/load corresponds to faster speed of the header drive).

The controller 210 may be configured to generate control signals for controlling the operation of respective actuators, for example as may be associated with the various drive units. Such control systems may be independent or otherwise integrated together or as part of a machine control unit in various manners as known in the art.

In various embodiments as disclosed herein, respective drive units for various rotating crop material processing elements may be provided with separate hardware assemblies to enable independent control commands and operations for the respective elements during an unplugging operation. For example, separate drive pumps and drive motors may be provided for each of a header and auger (and/or separate hardware associated with for example at least one conditioning roller controllable in position to define a roll gap), or decoupling with respect to a clutch/gear assembly. Drive units for rotatable components may further be configured with mechanisms in a manner as known in the art to be selectively moveable or otherwise convertible between forward and reverse drive positions to enable forward and reverse rotation, respectively.

It is understood that the controller 210 described herein may be a single controller having all of the described functionality, or it may include multiple controllers wherein the described functionality is distributed among the multiple controllers.

Various “computer-implemented” operations, steps or algorithms as described in connection with the controller 210 or alternative but equivalent computing devices or systems can be embodied directly in hardware, in a computer program product such as a software module executed by one or more processors 212, or in a combination thereof. The computer program product can reside in data storage 214 such as RAM memory, flash memory, ROM memory, EPROM memory, EEPROM memory, registers, hard disk, a removable disk, or any other form of computer-readable medium known in the art. An exemplary computer-readable medium can be coupled to the processor 212 such that the processor 212 can read information from, and write information to, the memory/storage medium. In the alternative, the medium can be integral to the processor 212. The processor 212 and the medium can reside in an application specific integrated circuit (ASIC). The ASIC can reside in a user terminal. In the alternative, the processor 212 and the medium can reside as discrete components in a user terminal.

The term “processor” 212 as used herein may refer to at least general-purpose or specific-purpose processing devices and/or logic as may be understood by one of skill in the art, including but not limited to a microprocessor, a microcontroller, a state machine, and the like. A processor 212 can also be implemented as a combination of computing devices, e.g., a combination of a digital signal processor (DSP) and a microprocessor, a plurality of microprocessors, one or more microprocessors in conjunction with a DSP core, or any other such configuration.

The controller 210 may include communications devices to enable the controller 210 to send signals to and/or receive signals from the drive units of the control system 200, the sensors of the control system 200, the user interface 260, and/or other devices. In some embodiments, the communication devices may provide two-way communication between the controller 210 and some or all of the other components. The controller 210 may communicate with these components in various known ways, including via a CAN bus, via wireless communication (e.g., Wi-Fi, BLUETOOTH™, etc.), via hydraulic communication means, or otherwise.

As noted above, various operations as disclosed herein may be executed via a controller 210 for a given work machine 100, wherein the controller may be a discrete device or integrated with a vehicle control system or equivalent. In some embodiments, operations may further or in the alternative be executed via a distributed system including one or more remote processors, such as for example may be associated with hosted servers in a cloud computing platform or mobile user devices, independently or in association with a local controller for each of one or more separate work machines.

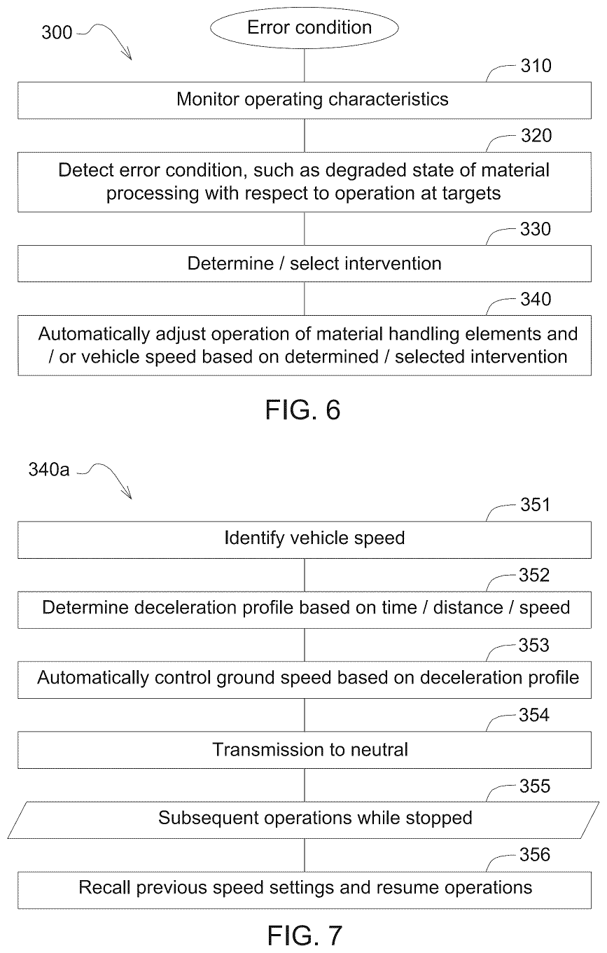

Referring next to FIG. 6, an embodiment of a method 300 may now be described, particularly with respect to automating at least a portion of removal of blockage in a crop material processing system. In the context of a work machine as disclosed herein, such as for example a harvester, windrower, or the like having a front-mounted header and a converging auger for processing crop material, a blockage or plug may be encountered in use of the header that prevents the flow of crop material through the header to the feederhouse for subsequent downstream processing. It should be appreciated that the blockage may be caused by, or otherwise associated with, an excess accumulation of crop material, soil, debris, particulates, foreign matter, or the like. Additionally, in some cases, the blockage may be caused by, or otherwise associated with, a stationary obstacle or object.

The illustrated method 300 includes a step 310 of monitoring one or more operating characteristics associated with the work machine 100, the operating characteristics depending in various embodiments on the type of application. Exemplary such characteristics may include, without limitation, header drive motor speed and/or pressure, auger drive motor speed and/or pressure, cross belt motor pressure, belt tension, ground speed, and the like

The illustrated method 300 further includes a step 320 of predicting and/or detecting an error condition, and more particularly a blockage or equivalent degraded state with respect to one or more crop material processing elements of the work machine. While an error condition in the context of the present disclosure may typically comprise blockage, in various embodiments an error condition may more generally relate to a degraded state of material processing with respect to operation at specified targets, including for example streaked cutting, poor conditioning, clumped windrows, and the like, none of which explicitly relate to crop material plugging.

As previously noted herein, an error state may be predicted, detected, or otherwise ascertained from monitored characteristics, directly in some cases but otherwise based for example on a comparison of one or more measured values relative to commanded values. In some embodiments, a blockage may provide, or otherwise be attributed to, an audible event indicating the presence of the blockage. In one example, a noise emitted by a torque-transmitting mechanism (e.g., a clutch, brake, shaft, gear, or the like) may indicate the presence of the blockage. In other embodiments, however, the blockage may provide, or otherwise be attributed to, another event. For example, at least in some embodiments, the blockage may be associated with a decrease in a measured rotational speed of a component of the header, an increase in measured header drive motor pressure, etc.

The illustrated method 300 further includes a step 330 of receiving, selecting, or otherwise determining an intervention responsive to the detected error condition. The type of intervention may be predetermined for a type of work machine, or may relate to selectable options.

For example, an intervention may be limited in scope to the automatic control of ground speed upon detecting degradation in crop processing as further described below. Spikes or large variations in conditioner drive torque can indicate windrow clumping that may be resolved by adjusting ground speed and correspondingly adjusting crop flow.

Alternatively, subsequent operations associated with automatic removal of the plugged crop material such as for example reversal of the crop material processing elements may be part of the determined intervention. Reversal of the crop material processing elements may still further alternatively be performed without a preceding automatic control of the ground speed to zero, wherein for example an operator may retain responsibility for ground speed control. In some embodiments, a configurable delay may be provided before a determined intervention action is provided after detecting an error (blockage), or a manual signal from the operator may be required before initiating actions such as reversal of the crop material processing elements, wherein for example the ground speed has manually been reduced to zero.

The illustrated method 300 further includes a step 340 of automatically adjusting operation of relevant crop material processing elements and/or the work machine ground speed based on the determined intervention, corresponding to the predicted and/or determined error condition.

As represented in FIG. 7, a first exemplary embodiment 340a of an executed intervention is described wherein the ground speed of a work machine is automatically controlled responsive to a detected blockage. Upon, or prior to, detection that one or more crop material processing elements have become plugged, the work machine ground speed is identified (step 351), for example using a ground speed sensor, a position sensor, a commanded ground speed value, and/or the like, wherein a deceleration profile may be determined (step 352) based on the ground speed, alone or further in view of additional factors such as for example a time and/or distance to a desired stopping point, a specified delay, etc.

The ground speed for the work machine may then be automatically controlled (step 353), in an embodiment utilizing electrohydraulic drive control, to direct the ground speed to zero and in accordance with the deceleration profile. The transmission for the work machine may then be shifted to neutral (step 354), wherein subsequent operations may be performed for manual or automatic removal of the crop material plugging the work machine elements (step 355).

Upon completion of the operations for removal of the plugged crop material, or otherwise upon a signal that such an operation is not to be performed, the harvesting operation may be resumed (step 356). In an embodiment, an operator may investigate the blockage and deem a further removal operation to be unnecessary, wherein a manual signal may be provided to clear the intervention state. Resumption of the harvesting operation may in various embodiments include retrieval of operation settings prior to the time of the detected blockage.

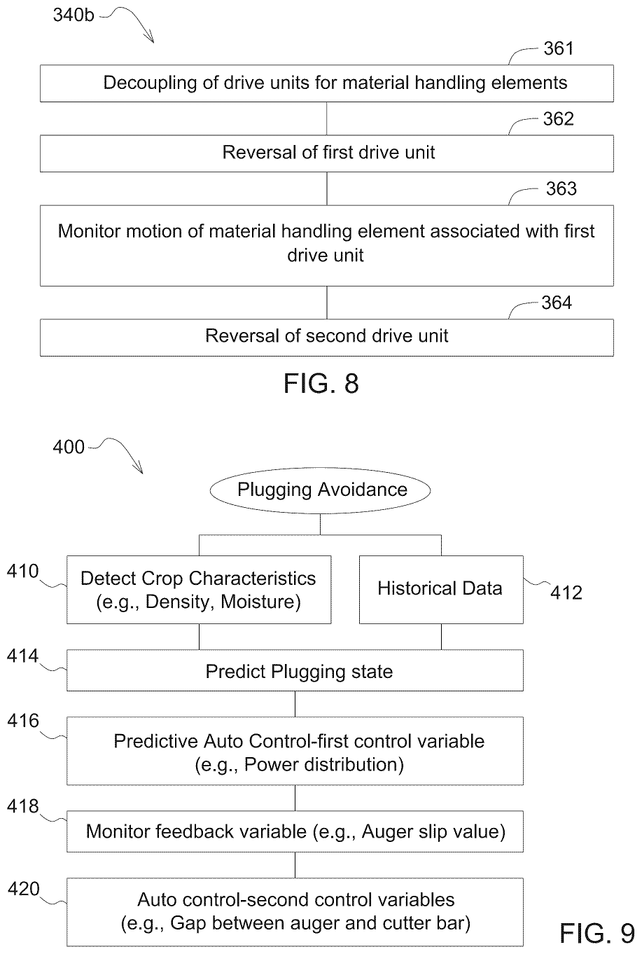

As represented in FIG. 8, a second exemplary embodiment 340b of an executed intervention is described wherein one or more crop material processing elements of a work machine are automatically controlled responsive to a detected error condition such as degradation in crop material processing.

The illustrated embodiment may for example be enabled by decoupling of respective drive units for a plurality of crop material handling elements (step 361), such as for example the header and auger of a windrower as the work machine. The intervention may subsequently include automatically reversing at least one of the drive units, independently of the other drive units (step 362). In such an embodiment, motion may be monitored for the crop material handling element (e.g., the header) associated with the drive unit being reversed (step 363), wherein upon detecting reversal of that drive unit, one or more other drive units are also reversed automatically (step 364).

Such reversal of motion for the other drive units (e.g., auger) may be performed in parallel or subsequently with respect to the first drive unit (e.g., for the header). Reversal of various drive units corresponding to respective crop material processing elements in a cutting system may accordingly be handled automatically, for example independent of different header types among other factors.

In an alternative embodiment, upon detecting a crop material blockage, for example by monitoring the pressure and/or load values associated with a hydraulic/electric motor for a header and/or auger in a windrower work machine, reversal of the rotational motion for drive units is not automatically initiated but instead is actuated manually from the user interface. Reversal of respective drive units, e.g., associated with the header and the auger, may be independently actuated by providing separate interface tools (e.g., joysticks, switches, buttons), for example after a configurable delay or an end of line condition for the respective work machine. As with other embodiments, such a system may favorably enable reversal of various drive units corresponding to respective crop material processing elements in a cutting system to be handled automatically, for example independent of different header types among other factors.

As illustrated in FIG. 9, a method 400 for proactive avoidance of error conditions such as plugging or other degradation in crop material processing may be described wherein one or more crop material processing elements of a work machine are automatically controlled responsive to a predicted error condition.

The method 400 may in various embodiments be performed alongside the method 300, or independently of the method 300, and one of skill in the art may readily appreciate aspects of the method 400 being supported by previously described aspects or steps according to method 300, or vice versa, even where not explicitly illustrated herein.

The method 400 includes a step 412 of input data collection for sensing one or more crop characteristics with respect to as-yet unprocessed (e.g., standing) crop in an area to be traversed by the work machine. As previously described herein, sensors for detecting relevant crop characteristics such as density and/or moisture are known in the art, and IR-UWB radar technology, lidar sensors, and the like are expressly contemplated, but without limitation on other sensing technologies which are within the scope of the present disclosure. In an embodiment, one or more such sensors may be mounted in a forward-looking arrangement, for example with a first sensor proximate to the ground surface and on a front-mounted implement and with a second sensor mounted on top of the operator cab. The one or more sensors may preferably provide inputs representative of the crop characteristics in a measurement area at least encompassing a width of the cutting mechanism and forward of the cutting mechanism.

In some embodiments, the method 400 may further include a step 414 of selectively retrieving historical data, for example corresponding to previously sensed or calculated crop characteristics in the work area or portion of the work area being traversed by the work machine.

Historical data may comprise integrated data with respect to previous passes in a current work operation, so as to better identify for example portions of the work area which may be more susceptible to error conditions based on real-time and potentially transient ambient conditions in the work area.

Historical data may include mapped data with respect to previous error conditions (e.g., plugging occurrences) for the work area or portion thereof, and may further integrate historical error conditions for the work machine itself, for example to enable prediction and/or determination of error conditions based at least in part on trends for the particular work machine, or equipment/implements mounted thereon.

Historical data may further or alternatively include models developed over time for correlation of the respective inputs being collected (not limited to the crop characteristic values but also potentially including machine operating characteristics and the like) with crop characteristic values to be calculated such as relative crop density, or with error conditions to be predicted, etc.

The illustrated embodiment of method 400 further includes a step 414 of predicting an error condition corresponding to crop material blockage based on the input data (e.g., sensed real-time data and optionally further historical data and/or models). Such a step may for example include comparison of detected crop characteristic values such as relative crop density values for crop approaching the infeed area of the work machine to specified tolerance levels. Tolerance levels may include threshold levels, bands, or the like. Threshold levels, bands, and the like may be specified and static, or may be dynamic in nature and responsive to changing operating conditions, modeled correlations between operating conditions and observed error conditions, and the like.

In step 416, the illustrated embodiment of method 400 continues with automatic control of one or more first control variables based on a predicted error condition such as for example a plugged condition or other degradation in the crop material processing.

In one example, wherein the work machine comprises a cutting mechanism (e.g., cutter bar with rotary blades) and a component for transverse movement of crop material (e.g., converging auger) having been cut by the cutting mechanism, further upon calculating that the relative crop density value for crop material approaching the infeed area of the work machine exceeds a defined threshold, the method step 416 may include adaptively adjusting power distribution to the cutting mechanism and the converging auger. In other words, if the calculated density increases, a rotational speed for the converging auger and/or the cutter bar will also be increased. This, in turn, will increase the crop flow at the converging auger bar and the conditioner rollers. One of skill in the art may appreciate that the slip ratio, for example as relating to the converging auger in an exemplary crop material processing application for a work machine as disclosed herein, is a function of crop density, rotational speed of the converging auger, crop length, forward speed of the work machine, moisture, and the like. With a reduced crop density and adaptive crop mass movement according to the method 400, the slip ratio may accordingly also be maintained within a normal range.

The converging auger and the cutting mechanism in a representative embodiment are linked together using gears, and their power is controlled by a hydraulic motor. A pressure sensor may be provided for measuring the power distribution, which can be adjusted by changing the pressure of valves without affecting the forward speed of the work machine.

In another example of step 416, complementary or alternatively with respect to the preceding example, a mechanism may be triggered based on one or more calculated values exceeding a specified maximum threshold to adjust a gap between the converging auger and the cutting mechanism. Such a mechanism may include an actuator inline with the conditioner rollers, which can be calibrated for minimum and/or maximum movement thresholds.

The method 400 may further include a step 418 of monitoring one or more feedback variables associated with or otherwise indicative (directly or indirectly) of results from the predictive response in step 416. In one example, a calculated slip ratio associated with the converging auger is continuously monitored as a feedback value. Based on the received values for the one or more monitored feedback variables, a further step 420 may include automatic control of one or more control variables based thereon. The control variables in step 420 may be the same as the control variables in step 416, may overlap with the control variables in step 416, or may be a different set of variables altogether.

In an embodiment, when the slip ratio of the converging auger is near a moderate level, the controller may be configured to increase the gap between the converging auger and the cutter bar using a control algorithm, with an objective being to further aid in pushing the accumulated crop material at a faster rate to the conditioner side. The gap may subsequently be reduced to a nominal level. One of skill in the art may appreciate that the slip ratio may be used to predict and/or detect error conditions such as plugging of crop material, and to aid in distributing the appropriate power to, e.g., the header assembly for successfully moving the high-density crop flow at the converging auger.

In an embodiment, as previously noted above, data analytics for example including modeling techniques such as machine learning or the like may utilize captured data relating to parameters such as crop type, crop length, moisture content, crop density, and forward speed of the work machine, etc., to generate a pattern and predict possible plugging scenarios during actual machine operation. Regression analysis may further or alternatively be performed to identify an optimum header speed, cutter bar speed, etc., to drive the work machine and set parameters in advance for different work area terrain, or in association with subsequent passes on the same work area.

While an embodiment of the method 400 for proactive avoidance of error conditions in crop material processing is described above wherein one or more crop material processing elements of a work machine are automatically controlled responsive to a predicted error condition, it may be understood that in other embodiments within the scope of the present disclosure various steps in a predictive method may be performed semi-automatically or manually. For example, predictive analysis may be performed and the results conveyed to an operator via a display or other audio-visual equivalents, wherein the operator may elect to manually incorporate prompted settings, alter proposed settings, or the like.

It should be noted that, although the various methods 300, 400, and respective embodiments thereof are described with respect to particular examples of work machines such as windrowers, the methods 300, 400 as disclosed herein may effectively be implemented in other work machines, for example hay and forage machines, having equivalent infeed challenges.

The various methods 300, 400 and respective embodiments and/or alternatives thereof may comprise using a crop plugging area map generator to generate a field map indicative of a crop plugging area at identified locations in a field comprising the target crop based at least on the crop plugging areas of the target field. That is, the target crop plugging areas data, which can store the data and generate a map that displays indications of the identified crop plugging areas (e.g., for historical data collection, and/or visual representation to an operator). In some embodiments, methods as disclosed herein can comprise using a user interface disposed at an operator position to display information indicative of the crop plugging, a map illustrating crop condition, and/or a setting of the windrower implement. That is, for example, the crop plugging areas can be displayed to the operator on the user interface, along with proposed adjustments to meet thresholds for crop conditions, the actual thresholds. In this way, the operator can choose to make their own adjustments, use the automated adjustments, select to engage or disengage the adjustments, or make other harvesting decisions for adjusting the implement based on the displayed data.

Accordingly, a method 300 as disclosed herein, or equivalent thereof, may in some embodiments include, upon detecting an error condition corresponding to crop material blockage, mapping a location corresponding to the error condition (or generating information comprising the location and the error condition to another device for performing such mapping), wherein for example detected plugging conditions may be utilized for assisting in predictions, interventions, and the like in subsequent operations.

Likewise, a method 400 as disclosed herein, or equivalent thereof, may in some embodiments include accessing a stored map including or referencing historical information such as previously detected error conditions corresponding to crop material blockage in the same work area, or corresponding to a current work operation such as for example the current work machine or type of work machine, the type of crop being processed, etc. The mapped information may be used for example to assist in predicting error conditions, selecting interventions, and conveying associated information to the operators/users.

As used herein, the phrase “one or more of,” when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item B and item C.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A method of operating a self-propelled agricultural work machine, the work machine comprising a first crop material processing element linked to a first drive unit, a second crop material processing element linked to a second drive unit, and an engine linked to a propulsion drive unit, the method comprising:
in real-time with respect to a first operating mode of the work machine in a work area comprising crop material, sensing one or more crop characteristics for the crop material in the work area, and/or one or more operating characteristics for each of the propulsion drive unit, the first drive unit, and the second drive unit;
based on at least one of the sensed one or more crop characteristics and/or one or more operating characteristics, automatically predicting and/or determining an error condition corresponding to crop material blockage;
transitioning to a second operating mode, wherein one or more of the propulsion drive unit, the first drive unit, and the second drive unit are controlled according to an intervention plan associated with the predicted and/or determined error condition; and
resuming the first operating mode upon completion of the intervention plan associated with the predicted and/or determined error condition.

2. The method of claim 1, wherein:
the sensed one or more crop characteristics comprise density and/or moisture of the crop material in the work area;
a first error condition is predicted based on the sensed density and/or moisture of the crop material in the work area relative to respective tolerances; and
the second operating mode responsive to the first error condition comprises controlling power distribution with respect to at least the first drive unit.

3. The method of claim 2, wherein:
the first crop material processing element comprises at least one component for transverse crop movement and the second crop material processing element comprises a cutting mechanism forward of the first crop material processing element;
a second error condition is determined based at least in part on a slip ratio corresponding to the first crop material processing element; and
the second operating mode responsive to the second error condition comprises controlling a gap between the first crop material processing element and the second crop material processing element.

4. The method of claim 1, wherein the error condition is automatically determined at least with respect to a difference between a sensed actual value for at least one of the monitored operating characteristics and a corresponding expected value.

5. The method of claim 1, wherein the error condition is automatically determined at least with respect to a difference between a sensed crop input throughput value and a sensed crop output throughput value.

6. The method of claim 1, wherein:
the first crop material processing element comprises at least one component for transverse crop movement and the second crop material processing element comprises a cutting mechanism forward of the first crop material processing element; and
the second operating mode comprises generating control signals for reversing rotational motion provided by at least one of the first drive unit and the second drive unit, independent of rotational motion provided by the other of the first drive unit and the second drive unit.

7. The method of claim 6, comprising, upon determining the error condition, suspending the first operating mode and generating an alert to a user interface associated with the work machine, wherein the second operating mode is initiated based on user input from the user interface.

8. The method of claim 6, comprising monitoring rotational motion provided by at least one of the first drive unit and the second drive unit, and upon detecting the automatic reversal of rotational motion provided by one of the first drive unit and the second drive unit, further automatically reversing rotational motion provided by the other of the first drive unit and the second drive unit.

9. The method of claim 8, wherein a speed of rotational motion provided by the first drive unit is controlled based at least in part on a monitored speed of rotational motion provided by the second drive unit.

10. The method of claim 1, wherein the first crop material processing element comprises a conditioning roller and the second crop material processing element comprises a cutting mechanism, and wherein the second operating mode comprises generating control signals for automatically reversing rotational motion provided by the second drive unit and generating control signals to the first drive unit for automatically adjusting a roll gap associated with the conditioning roller.

11. The method of claim 1, wherein the first crop material processing element comprises at least one component for transverse crop movement and the second crop material processing element comprises a conditioning roller, and wherein the second operating mode comprises generating control signals for automatically reversing rotational motion provided by the first drive unit and generating control signals to the second drive unit for automatically adjusting a roll gap associated with the conditioning roller.

12. The method of claim 1, wherein the intervention plan comprises generating a deceleration profile based on at least a detected ground speed and the at least one of the one or more monitored operating conditions associated with the predicting and/or determining of the error condition, and wherein the second operating mode comprises generating control signals for automatically controlling the propulsion drive unit to a speed of zero according to the deceleration profile.

13. A self-propelled agricultural work machine comprising:
a first crop material processing element linked to a first drive unit;
a second crop material processing element linked to a second drive unit;
an engine linked to a propulsion drive unit;
one or more sensors configured to generate signals representing one or more crop characteristics for unprocessed crop material in a work area to be traversed by the work machine, and/or operating characteristics for each of the propulsion drive unit, the first drive unit, and the second drive unit; and
a controller functionally linked to the one or more sensors, the propulsion drive unit, the first drive unit, and the second drive unit, and configured:
during a first operating mode, based on at least one of the one or more crop characteristics and/or operating characteristics, to automatically predict and/or determine an error condition corresponding to crop material blockage;
to transition to a second operating mode, wherein one or more of the propulsion drive unit, the first drive unit, and the second drive unit are controlled according to an intervention plan associated with the predicted and/or determined error condition; and
to resume the first operating mode upon completion of the intervention plan associated with the predicted and/or determined error condition.

14. The work machine of claim 13, wherein:
the sensed one or more crop characteristics comprise density and/or moisture of the crop material in the work area;
a first error condition is predicted based on the sensed density and/or moisture of the crop material in the work area relative to respective tolerances; and
the second operating mode responsive to the first error condition comprises controlling power distribution with respect to at least the first drive unit.

15. The work machine of claim 14, wherein:
the first crop material processing element comprises at least one component for transverse crop movement and the second crop material processing element comprises a cutting mechanism forward of the first crop material processing element;
a second error condition is determined based at least in part on a slip ratio corresponding to the first crop material processing element; and
the second operating mode responsive to the second error condition comprises controlling a gap between the first crop material processing element and the second crop material processing element.

16. The work machine of claim 13, wherein:
the first crop material processing element comprises at least one component for transverse crop movement and the second crop material processing element comprises a cutting mechanism forward of the first crop material processing element; and
the controller is configured during the second operating mode to generate control signals for reversing rotational motion provided by at least one of the first drive unit and the second drive unit, independent of rotational motion provided by the other of the first drive unit and the second drive unit.

17. The work machine of claim 16, wherein the controller is configured, upon determining the error condition, to suspend the first operating mode and generate an alert to a user interface, wherein the second operating mode is initiated based on user input from the user interface.

18. The work machine of claim 16, wherein the controller is configured to:
monitor rotational motion provided by at least one of the first drive unit and the second drive unit; and
upon detecting the automatic reversal of rotational motion provided by one of the first drive unit and the second drive unit, to further automatically reverse rotational motion provided by the other of the first drive unit and the second drive unit,
wherein a speed of rotational motion provided by the first drive unit is controlled based at least in part on a monitored speed of rotational motion provided by the second drive unit.

19. The work machine of claim 13, wherein:
the first crop material processing element comprises a conditioning roller and the second crop material processing element comprises a cutting mechanism forward of the conditioning roller; and
the controller is configured in association with the second operating mode to generate control signals for automatically reversing rotational motion provided by the second drive unit and to generate control signals to the first drive unit for automatically adjusting a roll gap associated with the conditioning roller.

20. The work machine of claim 13, wherein the first crop material processing element comprises at least one component for transverse movement of crop material and the second crop material processing element comprises a conditioning roller, and wherein the controller is configured in association with a second operating mode to generate control signals for automatically reversing rotational motion provided by the first drive unit and to generate control signals to the second drive unit for automatically adjusting a roll gap associated with the conditioning roller.
